(19) United States
(12) Patent Application Publication
(10) Pub. No.: US 2015/0230295 A1
(43) Pub. Date: Aug. 13, 2015

(54) APPARATUS FOR COOKING FOOD PRODUCTS

(71) Applicant: Electrolux Professional S.p.A., Pordenone (IT)

(72) Inventors: Alessandro MORASSUT, Sacile (PN) (IT); Michele SIMONATO, Udine (IT); Fabio TURCO, Cordenons (PN) (IT)

(21) Appl. No.: 14/616,034

(22) Filed: Feb. 6, 2015

(30) Foreign Application Priority Data
Feb. 10, 2014 (EP) 14154473.4

(51) Int. Cl. H05B 6/64; H05B 6/76

(52) U.S. Cl. CPC H05B 6/6482; H05B 6/76

(57) ABSTRACT

An apparatus for cooking food products includes a first heating plate adapted to support the food products; a second heating plate adapted to face the food products during cooking; a first resistive heating element associated with the first heating plate and adapted to generate infrared radiation for heating the food products during the cooking; a second resistive heating element associated with the second heating plate and adapted to generate infrared radiation for heating the food products during the cooking, and at least one microwave generator configured to selectively generate microwave radiation for heating the food products during the cooking The first heating plate and/or the second heating plate is made of a material that is at least partially transparent to microwave radiation and not transparent to infrared radiation, so as to increase its temperature by infrared radiation absorption to provide heat to the food products by heat conduction.

The present invention refers to the cookware field.

Widely known in the art are currently broilers, or griddles, that are used to cook food products of the most varied kind, such as hamburgers, toasted rolls, meat in general, and the like. For this purpose, griddles comprise at least one heating plate associated with one or more resistive heating elements.

A number of griddles to be found currently on the marketplace have—further to a lower or bottom heating plate on which the products to be cooked are placed—an upper or top heating plate that is adapted to be brought in proximity of the lower or bottom one so as to have the products cooked on both sides simultaneously, thereby reducing the overall time required to handle the same products.

According to solutions known in the art, a first resistive heating element may be located under the lower heating plate and a second resistive heating element may be located above the higher heating plate. This design is quite simple and effective, having the advantage of allowing an easy and fast maintenance, since the two heating plates may be easily removed for being cleaned.

Apparatuses of this kind, however, have a main drawback in that they are not capable of cooking the food products completely; in fact, such food products are usually just heated up or browned outside, while remaining substantially uncooked, i.e., in their raw state, inside. This drawback is exacerbated in case the food products to be cooked are large.

In order to solve this drawback, griddles designed to cook food products by exploiting a combination of heat produced by the resistive heating elements and heat produced by electromagnetic radiation in the microwave spectrum (hereinafter simply referred to as “microwave radiation”) are also available in the market. Thanks to the action of the electromagnetic radiation in the microwave spectrum, which is able to deeply penetrate into the food products to be cooked, said apparatuses allow to evenly heat also the inner portions of such food products, improving the cooking quality and increasing the cooking speed. In order to exploit the microwave action benefits, said apparatuses have to include one or more microwave generators adapted to generate electromagnetic radiation in the microwave spectrum. The microwave generator(s) is(are) typically located under and/or at the side of the bottom heating plate.

In the present description and claims with “resistive heating element” it is intended any device adapted to provide heat by exploiting the Joule effect, i.e., the generation of heat produced by the passage of electric current across a conductor material. Conversely, the electromagnetic radiation in the microwave spectrum generated by a microwave generator element is adapted to provide heat by directly causing polarized molecules in the food to rotate and build up thermal energy (said process is known as dielectric heating).

For example, U.S. Pat. No. 7,449,665, which has been filed by this same applicant, discloses an apparatus for cooking food products on both sides thereof, comprising a base member associated to a bottom heating surface, a first electric heating element located between the base member and the bottom heating surface, an upper movable member associated to a top heating surface, a second electric heating element located between said upper member and said top heating surface, and one or more microwave generators housed in the base member; when said upper member is lowered, the top heating surface comes to lie opposite to the bottom heating surface so as to form a cooking cavity therebetween. Said first electric heating element is separated from the bottom heating surface by a hollow space and the microwave generator is placed in such position, with the use of appropriate wave-guide means, as to allow the microwaves issuing therefrom to propagate towards said hollow space and, eventually, towards the bottom surface of said bottom heating surface.

In griddles like the one previously described, designed to exploit a combination of heat produced by resistive heating elements and heat produced by microwave radiation for cooking food products, the bottom heating plate is made of a material that is resistant to high temperatures, transparent or partially transparent to infrared radiation, as well as transparent or partially transparent to microwave radiation, such as quartz. In this way, heat irradiated by the resistive heating element(s) located under the bottom heating plate and microwave radiation generated by the microwave generator(s) located under and/or at the side of the bottom heating plate are able to reach the food supported by the bottom heating plate without being shielded by the latter.

However, a bottom heating plate made of quartz, although capable of being efficiently crossed by both infrared and microwave radiation, is not devoid of drawbacks.

Indeed, quartz is a material that is intrinsically fragile. Therefore, a heating plate made of quartz should be cleaned with great care, avoiding the use of harsh detergents and cleaning tools which cause an excessive rubbing force. However, users of griddles typically do not follow these recommendations, since a correct cleaning operation would require an excessive amount of time. Instead, heating plates are frequently cleaned using aggressive cleaning tools, such as steel wool pads or steel scouring pads, which may cause the formation of superficial micro-cracks, capable of propagating across the quartz heating plate up to bring the quartz heating plate to breakage.

Moreover, since quartz is a material having a low heat capacity, a heating plate made of quartz has a scarce thermal inertia. Therefore, once the heating plate is brought to a desired target temperature, if the boundary conditions are changed (e.g., when a new, cold, food product to be cooked is placed on the heating plate), the scarce thermal inertia of such material causes an abrupt decreasing in the heating plate temperature, lowering the cooking quality.

In order to reduce the occurrence of micro-cracks formation, a baking paper sheet, for example made of Polytetrafluoroethylene (PTFE), may be provided to cover the surface of the heating plate made of quartz, so that, during the cooking operations, the pieces of food to be cooked are not in direct contact with said surface. In this way, the surface of the heating plate made of quartz would get less dirty with the use, reducing the necessity of performing the abovementioned cleaning operations capable of causing the degradation of the heating plate if carried out exploiting harsh detergents and aggressive cleaning tools.

However, in order to maintain its effectiveness, said baking paper sheet should be replaced with a relatively high frequency (e.g., once a day).

Moreover, by using baking paper sheets, the drawbacks caused by the intrinsic low heat capacity of the quartz are still not solved.

In view of the above, the Applicant has faced the problem to improve the already known solutions for providing a cooking apparatus designed to exploit a combination of heat produced by the resistive heating elements and heat produced by electromagnetic radiation in the microwave spectrum, by solving, or at least reducing, the drawbacks caused by a bottom heating plate of the cooking apparatus that is made of quartz.

The Applicant has found that in a cooking apparatus designed to exploit a combination of heat produced by the resistive heating elements and heat produced by electromagnetic radiation in the microwave spectrum, if food products are cooked providing heat produced by the resistive heating elements through heat conduction instead of through infrared radiation, it is possible to use a bottom heating plate made of a material that is not affected (or at least that is less affected) by the abovementioned drawbacks.

An aspect of the present invention provides for an apparatus for cooking food products. The apparatus comprises a first heating plate adapted to support the food products, and a second heating plate adapted to face the food products during a cooking operation. The apparatus further comprises a first resistive heating element associated with the first heating plate and adapted to generate infrared radiation for heating the food products during the cooking operation, a second resistive heating element associated with the second heating plate and adapted to generate infrared radiation for heating the food products during the cooking operation, and at least one microwave generator element configured to selectively generate microwave radiation for heating the food products during the cooking operation. At least one among the first heating plate and the second heating plate is made of a material that is transparent or at least partially transparent to microwave radiations and at the same time not transparent to infrared radiation, in such a way that said at least one among the first heating plate and the second heating plate is adapted to increase its temperature by infrared radiation absorption to provide heat to the food products by heat conduction.

According to an embodiment of the present invention, said material is a ceramic material.

In this document, by “ceramic material” it is intended any compound comprising processed (e.g., sintered) ceramic particulate, in granular and/or fibrous form.

According to an embodiment of the present invention, said ceramic material is a ceramic material for which at least one among the following relationships is fulfilled:
k_{ic}/Eα≧0.3 K√m;
δ_{f}/Eα≧30 K;
kK_{ic}/Eα≧1 W/√m, and
kδ_{f}/Eα≧30 W/m,
wherein:
K_{ic} is the fracture toughness resistance coefficient;
δ_{f} is the maximum tensile strength;
E is the Young's modulus;
α is the thermal expansion coefficient, and
k is the thermal conductivity coefficient.

According to an embodiment of the present invention, said ceramic material is silicon nitride.

According to an embodiment of the present invention, said ceramic material is aluminum oxide.

Said ceramic material has a dielectric loss factor preferably lower than 10⁻¹, more preferably lower than 10⁻².

According to an embodiment of the present invention, the apparatus further comprises a base member associated to the first heating plate, and an upper member associated to the second heating plate. The upper member is pivotally joined to the base member so that the upper member is adapted to be moved between: a) a resting position in which the upper member is spaced apart from the base member, and b) a cooking position in which the upper member and the base member are closed against each other to form a cooking cavity wherein the food products are cooked. The apparatus further comprises a support frame mechanically coupled with the first heating plate for supporting the first heating plate. The support frame is preferably located on a top portion of the base member.

According to an embodiment of the present invention, the base member comprises a gasket member along the border of the first heating plate to close interstices between the first heating plate and the support frame.

According to an embodiment of the present invention, the base member comprises a microwave choke member surrounding the first heating plate to prevent microwave radiation to leak outside the apparatus.

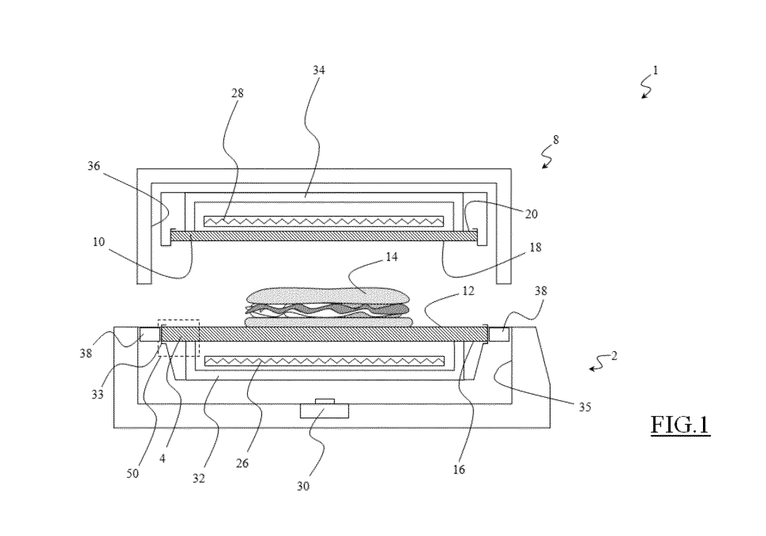

FIG. 1 is a side sectional view of an apparatus for cooking food with the upper member thereof raised in a resting position according to an embodiment of the present invention;

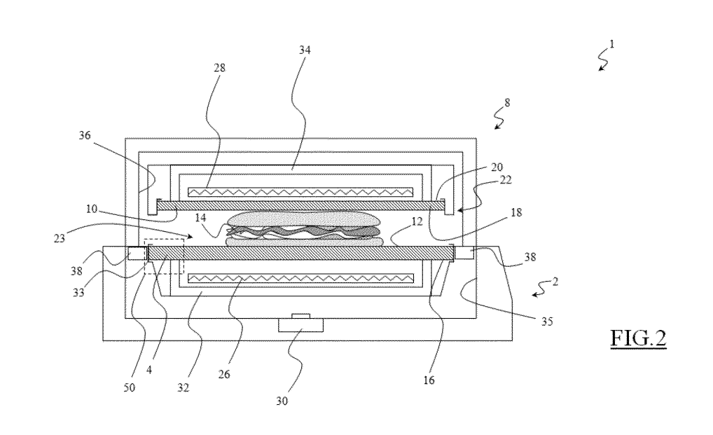

FIG. 2 is a side sectional view of the apparatus of FIG. 1 with the upper member thereof lowered into a cooking position, and

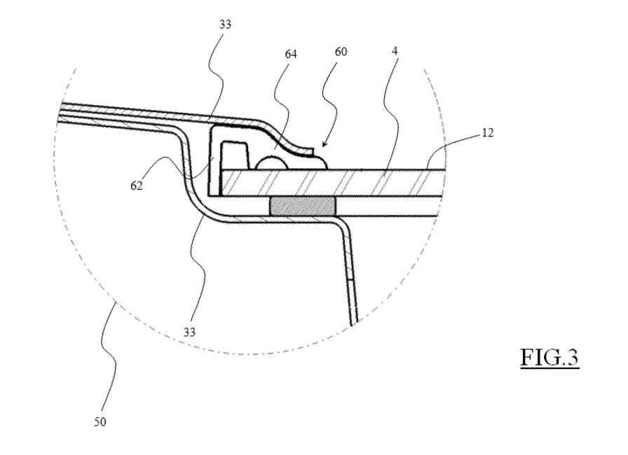

FIG. 3 is an enlarged view of a portion of the apparatus of FIGS. 1 and 2 showing how a border of the bottom heating plate is coupled with a support frame.

With reference to the drawings, FIGS. 1 and 2 are side sectional views of an apparatus 1 for cooking food products on both sides thereof, such as a griddle, according to an embodiment of the present invention. The apparatus 1 comprises a base member 2 associated to a bottom heating plate 4, and an upper member 8 associated to a top heating plate 10. The bottom heating plate 4 comprises a top surface 12 adapted to support food products 14 to be cooked and an opposite bottom surface 16. The top heating plate 10 comprises a bottom surface 18 adapted to face the food products 14 supported by the bottom heating plate 4 during the cooking operations, and an opposite top surface 20. The bottom heating plate 4 is preferably located on top of the base member 2 and the top heating plate 10 is preferably located at the bottom of the upper member 8.

Advantageously, the upper member 8 is pivotally joined (in a way that is not shown) to the base member 2 so that the upper member 8 may be moved between a raised, resting position (see FIG. 1), in which the upper member 8 is spaced apart from the base member 2, to a lowered, cooking position (see FIG. 2), in which said upper member 8 and said base member 2 are closed against each other.

The kind of movement needed to lower the upper member 8 onto the base member 2 can for instance be a rotary one about a hinging pin provided on the base member 2 or a simple translational one, or a combination of both. Anyway, these details shall not be explained any further, owing to them being generally and widely known to all those skilled in the art.

Said base member 2 and said upper member 8, when closed against each other in the cooking position as illustrated in FIG. 2, are adapted to define—in the volume comprised therebetween—an inner compartment 22 housing both the bottom and top heating plates 4, 10. Moreover, when said base member 2 and said upper member 8 are closed against each other in the cooking position, a cooking cavity 23 is formed wherein food products 14 are actually cooked. Said cooking cavity 23 is delimited from above by the bottom surface 18 of the top heating plate 10, and from below by the top surface 12 of the bottom heating plate 4.

The base member 2 comprises one or more bottom resistive heating elements 26 (one, in the figures) arranged under the bottom heating plate 4 and operable to generate infrared radiation for heating the food products 14. The upper member 8 comprises one or more top resistive heating elements 28 (one, in the figures) arranged above the top heating plate 10 and operable to generate infrared radiation for heating the food products 14.

The apparatus 1 further comprises, inside said base member 2, one or more (one, in the figures) microwave generator elements 30 configured to generate microwave radiation to be fed into the cooking cavity 23 for heating the food 14 supported by the bottom heating plate 4. The microwave generator elements 30 are preferably located under and/or at the sides of the bottom heating plate 4.

Expediently, the base member 2 comprises a partition element 32 made of thermally insulating but microwave transparent material, such as a ceramic material, which is arranged so as to extend in a position below the bottom resistive heating element 26 for thermally insulating the electric/electronic components housed in the base member 2 from the heat generated by the bottom resistive heating element 26 while at the same time allowing microwaves generated by the microwave generator element 30 to pass therethrough without any attenuating effect whatsoever. The bottom heating plate 4 is mechanically coupled with a, e.g., metallic, support frame 33, located on a top portion of said base member 2 above said partition element 32.

Similarly, the upper member 8 may comprise a partition element 34 made of thermally insulating material, which is arranged so as to extend in a position above the top resistive heating element 28. The top heating plate 10 is coupled with said upper member 8 below the partition element 34.

The base member 2 and the upper member 8 may be made of a metallic material so as to form a corresponding lower microwave shielding semi-shell 35 and a corresponding upper microwave shielding semi-shell 36, respectively, designed and arranged to ensure that, once said base member 2 and said upper member 8 are closed against each other in the cooking position, the microwave radiation generated by the microwave generator element 30 is confined within the apparatus 1. Alternatively, the base member 2 and/or the upper member 8 may be made of a non metallic material, such as plastic, with the inner walls thereof that are metalized so that, once the base member 2 and the upper member 8 are closed against each other in the cooking position, the microwave radiation generated by the microwave generator element 30 is still confined within the apparatus 1.

Advantageously, the base member 2 comprises a metallic microwave choke member 38, only schematically illustrated in the figures, surrounding the bottom heating plate 4 and extending parallel to the interstice that is formed between the upper member 8 and the base member 2 when the former is closed against the latter. The microwave choke member 38 comprises at least a choke channel (not illustrated) shaped so as to make microwave radiation to reflect against walls thereof so as to efficiently prevent microwave radiations from leaking outside the apparatus 1 through said interstice that is formed between the upper member 8 and the base member 2 when the former is closed against the latter.

According to an embodiment of the present invention, the bottom heating plate 4 is made of a material that is transparent or at least partially transparent to microwave radiations and at the same time not transparent to infrared radiation. In this way, while microwave radiation generated by the microwave generator element 30 may pass through the bottom heating plate 4, the infrared radiation emitted by the resistive heating element 26 cannot pass through the bottom heating plate 4, being instead absorbed by the latter. The infrared radiation absorbed by the bottom heating plate 4 causes the latter to increase its temperature. This allows food products 14 in contact with the bottom heating plate 4 to be cooked by heat conduction, i.e. through transfer of heat energy from the bottom heating plate 4 to said food products 14 due to the temperature gradient occurring between the former and the latter.

According to an embodiment of the present invention, the bottom heating plate 4 is made of a ceramic material.

Preferably, but not necessarily, the top heating plate 10 is made of a material that is transparent or partially transparent to infrared radiation, so that heat produced by the top resistive heating element 28 is able to reach the food 14 supported by the bottom heating plate 4. Nevertheless, for the top heating plate 10 a material that is not transparent to infrared radiation can be used as well. In one possible embodiment, the top heating plate 10 is made of a material which is transparent or at least partially transparent to microwave radiations and at the same time not transparent to infrared radiation, such as a ceramic material. In another possible embodiment, in order to better confine microwave radiation within the inner compartment 22, the top heating plate 10 is advantageously made of a material that is also non-transparent to microwave radiation.

Thanks to the presence of both the resistive heating elements 26, 28 and the microwave generator element 30, the apparatus 1 is in this way adapted to process any food product 14 that is placed upon said bottom heating plate 4 by both thermal effect and dielectric heating effect.

In fact, upon placing said food product 14 on the bottom heating plate 4, all it takes is lowering said upper member 8 so as to close it on said base member 2 in such a way that the top heating plate 10 contacts the top side of the food product 14 and in such a way to ensure that the thereby formed inner compartment 22 features a tightly sealed construction enclosing the cooking cavity 23. In this way, the cooking cavity 23 can be reached by the propagating microwave radiation that passes through said partition element 32 and bottom heating plate 4 in an ascending flow pattern, providing heat to the food product 14.

Moreover, since the infrared radiation emitted by the bottom resistive heating element 26 is absorbed by the bottom heating plate 4, said absorption causes the bottom heating plate 4 to increase its temperature. In this way, heat is transferred from the bottom heating plate 4 to the bottom side of the food product 14 in contact with the bottom heating plate 4 by heat conduction. In case the top heating plate 10 is made of a material that is not transparent to infrared radiation, the top heating plate 10 increases as well its temperature by infrared radiation absorption, and transfers heat to the top side of the food product 14 by heat conduction. In case instead the top heating plate 10 is made of a material that is transparent to infrared radiation, the food product 14 may be irradiated also by the infrared radiation emitted by the top resistive heating element 28.

The use of a ceramic material for forming the bottom heating plate 4 is particularly advantageous since ceramic materials are less fragile than quartz. Indeed, even if cleaned using aggressive cleaning tools, a bottom heating plate 4 made of ceramic material does not exhibit the formation of micro-cracks capable of extending across the bottom heating plate 4 up to bring the latter to break. Moreover, since ceramic materials have a higher heat capacity compared to quartz, a heating plate made of ceramic material exhibits a higher thermal inertia, ranging from approximately 1.5 to 2 times the thermal inertia of quartz. Therefore, a heating plate made of ceramic material allows to maintain a desired cooking temperature in a more stable manner even if new, cold, food products 14 are placed thereon, offering a better cooking quality. Furthermore, since with a bottom heating plate 4 made of ceramic material the food receives heat from the bottom resistive heating element 26 by heat conduction instead of by infrared irradiation, the browning of the surface of the food product 14 is advantageously increased.

According to an embodiment of the present invention, the top surface 12 of the bottom heating plate 4 may be made nonstick by changing the surface morphology of the top surface 12. For example, it is possible to modify its porosity and/or its roughness during the manufacturing process so as to achieve such nonstick properties.

According to an embodiment of the present invention, the choice of the ceramic material forming the bottom heating plate 4 is carried out by considering both the dielectric loss factor and the thermal shock resistance of the material. The ceramic material forming the bottom heating plate 4 should have a sufficiently low dielectric loss factor in order to allow that the bottom heating plate 4 is sufficiently transparent to microwave radiation, reducing thus the electromagnetic energy losses, as well a sufficiently high thermal shock resistance to avoid that the bottom heating plate 4 mechanically degrades with the formation of micro-cracks when subjected to high temperature variations.

The ceramic material forming the bottom heating plate 4 is selected to have a dielectric loss factor preferably lower than 10⁻¹, and more preferably lower than 10⁻².

According to an embodiment of the present invention, the ceramic material forming the bottom heating plate 4 is selected to have a sufficiently high thermal shock resistance not to mechanically degrade with the formation and/or the propagation of micro-cracks when subjected to temperature variations higher than 100° C.

According to an embodiment of the present invention, said ceramic material is selected based on its fracture toughness resistance coefficient K_{ic} and/or its maximum tensile strength δ_{f}. According to an embodiment of the present invention, said ceramic material having such sufficiently high thermal shock resistance is a ceramic material for which at least one among the following relationships is fulfilled:
1) K_{ic}/Eα≧0.3 K√m;
2) δ_{f}/Eα≧30 K;
3) kK_{ic}/Eα≧1 W/√m, and
4) kδ/Eα≧30 W/m,
   wherein E is the Young's modulus, α is the thermal expansion coefficient, and k is the thermal conductivity coefficient. As it is known to those skilled in the art, K_{ic}/Eα, δ_{f}/Eα, kK_{ic}/Eα and kδ_{f}/Eα, are indexes that provide a description of the thermal shock resistance of a material.

According to an embodiment of the present invention, the bottom heating plate 4 is made of silicon nitride. Silicon nitride is a material that fulfills all the four abovementioned relationships 1)-4).

According to another embodiment of the present invention, the bottom heating plate 4 is made of aluminum oxide processed in such a way to fulfill at least one among the four abovementioned relationships 1)-4). Unlike the silicon nitride, which always fulfills all the four relationships 1)-4), there exist different types of aluminum oxide processed in different types, fulfilling a different number of relationships among the relationships 1)-4). For example, there exist aluminum oxide types processed to have a crystalline structure such to fulfill only relationships 1) and 2), or such to fulfill only relationship 1).

Since both silicon nitride and aluminum oxide have a dielectric loss factor lower than 10⁻¹, a bottom heating plate 4 made of one of said materials is sufficiently transparent to the microwave radiation to allow microwave radiation generated by the microwave generator elements 30 to efficiently reach food products 14 placed on the bottom heating plate 4.

A bottom heating plate 4 made of silicon nitride has a thermal shock resistance such to sustain high thermal shocks without causing the formation of micro-cracks.

A bottom heating plate 4 made of aluminum oxide processed to fulfill at least one among the four abovementioned relationships 1)-4), has a thermal shock resistance such to allow the formation of micro-cracks when the bottom heating plate 4 is subjected to high thermal shocks, but said micro-cracks do not propagate across the bottom heating plate 4, avoiding the latter to break.

Silicon nitride and aluminum oxide have a mechanical resistance that is higher than the one of the quartz. A bottom heating plate 4 made of silicon nitride or aluminum oxide is also strongly resistant to mechanical shocks. Indeed, the peculiar microstructure of said materials allows the plate to absorb the energy of said mechanical shocks through the generation of corresponding micro-cracks, with said micro-cracks that do not propagate across the bottom heating plate 4, preserving the integrity thereof.

Moreover, silicon nitride has a heat capacity that is up to 50% higher than the heat capacity of quartz, while aluminum oxide has a heat capacity that is up to 100% higher than the heat capacity of quartz.

FIG. 3 is an enlarged view of a portion—identified in FIGS. 1 and 2 with reference 50—of the apparatus 1 showing how a border of the bottom heating plate 4 may be coupled with the support frame 33.

According to such embodiment, a gasket member 60 is provided along the border of the bottom heating plate 4, for example between the bottom heating plate 4 and the microwave choke member 38 (not illustrated in FIG. 3) to close any possible interstice between the bottom heating plate 4 and the support frame 33. In this way, it is avoided that fats and food residuals accumulate within said interstices, strongly reducing the formation of hot spots capable of attracting microwaves with consequence dangerous uncontrolled local heat increase.

According to the disclosed embodiment, the gasket member 60 has a first portion 62 extending perpendicular to the top surface 12 of the bottom heating plate 4 and in contact with the border of the bottom heating plate 4, and a second portion 64 which extends between a portion of the top surface 12 and a portion of the support frame 33, contacting both of them.

Naturally, in order to satisfy local and specific requirements, a person skilled in the art may apply to the solution described above many logical and/or physical modifications and alterations.

For example, although in the present description reference has been explicitly made to the use of materials that are transparent or at least partially transparent to microwave radiations and at the same time not transparent to infrared radiation for forming only the bottom heating plate, similar considerations apply if such materials are used for forming only the top heating plate, or for forming both the bottom heating plate and the top heating plate.

1. An apparatus (1) for cooking food products (14), the apparatus (1) comprising:
a first heating plate (4) adapted to support the food products (14);
a second heating plate (10) adapted to face the food products (14) during a cooking operation;
a first resistive heating element (26) associated with the first heating plate (4) and adapted to generate infrared radiation for heating the food products (14) during the cooking operation;
a second resistive heating element (28) associated with the second heating plate (10) and adapted to generate infrared radiation for heating the food products (14) during the cooking operation, and
at least one microwave generator element (30) configured to selectively generate microwave radiation for heating the food products (14) during the cooking operation,
characterized in that
at least one among the first heating plate (4) and the second heating plate (10) is made of a material that is transparent or at least partially transparent to microwave radiations and at the same time not transparent to infrared radiation, in such a way that said at least one among the first heating plate (4) and the second heating plate (10) is adapted to increase its temperature by infrared radiation absorption to provide heat to the food products (14) by heat conduction.

2. The apparatus (1) of claim 1, wherein said material is a ceramic material.

3. The apparatus (1) of claim 2, wherein said ceramic material is a ceramic material for which at least one among the following relationships is fulfilled:
K_{ic}/Eα≧0.3 K√m;
δf/Eα≧30 K;
kKic/Eα≧1 W/√m, and
kδf/Eα≧30 W/m,
wherein
Kic is the fracture toughness resistance coefficient;
δf is the maximum tensile strength;
E is the Young's modulus;
α is the thermal expansion coefficient, and
k is the thermal conductivity coefficient.

4. The apparatus (1) of claim 3, wherein said ceramic material is silicon nitride.

5. The apparatus (1) of claim 3, wherein said ceramic material is aluminum oxide.

6. The apparatus (1) of claim 1, wherein said ceramic material is a ceramic material having a dielectric loss factor lower than 10−1.

7. The apparatus (1) of claim 6, wherein said ceramic material is a ceramic material having a dielectric loss factor lower than 10−2.

8. The apparatus (1) of claim 1, further comprising:
a base member (2) associated to the first heating plate (4);
an upper member (8) associated to the second heating plate (10), the upper member (8) being pivotally joined to the base member (2) so that the upper member (8) is adapted to be moved between:
a) a resting position in which the upper member (8) is spaced apart from the base member (2), and
b) a cooking position in which the upper member (8) and the base member (2) are closed against each other to form a cooking cavity (23) wherein the food products (14) are cooked;
a support frame (33) associated to the base member (2) and mechanically coupled with the first heating plate (4) for supporting the first heating plate (4).

9. The apparatus (1) of claim 8, wherein the base member (2) comprises a gasket member (60) along the border of the first heating plate (4) to close interstices between the first heating plate (4) and the support frame (33).

10. The apparatus (1) of claim 8, wherein the base member (2) comprises a microwave choke member (38) surrounding the first heating plate (4) to prevent microwave radiation to leak outside the apparatus (1).
